(19) United States
(12) Patent Application Publication
(10) Pub. No.: US 2006/0186179 A1
(43) Pub. Date: Aug. 24, 2006

(54) Apparatus and method for bonding wires

(76) Inventors: Lee Robert Levine, New Tripoli, PA (US); Matthew G. Osborne, Hatboro, PA (US); Stephen E. Babinetz, Lansdale, PA (US); Jon William Brunner, Sellersville, PA (US)

Correspondence Address: KULICKE AND SOFFA INDUSTRIES, INC., 1005 VIRGINIA DRIVE, FORT WASHINGTON, PA, 19034, US

(21) Appl. No.: 11/064,283

(22) Filed: Feb. 23, 2005

(51) Int. Cl. B23K 31/02

(52) U.S. Cl. 228/180.5

(57) ABSTRACT

A wire bonder and a method of bonding a bonding wire to a bonding pad of a bonding location using the wire bonder are provided. The method includes forming a bonding ball at an end of the bonding wire, pre-deforming at least a portion of the bonding ball and bonding the pre-deformed ball to the bonding pad. The wire bonder includes a source of heat disposed adjacent a bonding tool to melt a portion of the bonding wire to produce the bonding ball at an end thereof, and a pre-deforming unit including a deforming surface to pre-deform at least a portion of the bonding ball.

### FIELD OF THE INVENTION

The present invention generally relates to a wire bonding method and, more particularly, a method of pre-deforming a bonding ball used to bond a wire, for example, between a semiconductor device and a substrate. The exemplary bonding method is particularly useful in preventing both cratering of bonding pads and cracking of semiconductor devices (e.g., dies, chips, VLSI devices) and/or substrates that are fragile, such as those with low dielectric constant layers.

### BACKGROUND OF THE INVENTION

Conventionally, wire bonding of electronic components may be accomplished by ball bonding one end of a fine wire to, for example, a metallic electrode of a semiconductor die and bonding the other end of the fine wire to, for example, a lead frame. A conventional ball bonding method includes forming a free air ball and ultrasonically bonding the free air ball.

However, certain of the conventional ball bonding methods have the following problem. The free-air ball can cause fracturing of a bonding location, for example, (1) cratering of the bonding location, especially if the hardness of the fine wire (e.g., including a surface of a die, a chip, etc.) or (2) cracking of the bonding location if the bonding location is fragile, for example, if the bonding location includes a low or an ultra low dielectric constant material. As used herein, the terms fracturing, cratering, and cracking are used interchangeably and are intended to refer to undesirable damage to any portion of a bonding location (e.g., surface damage to surface layers of the bonding location, a void (crater) in a bonding location, etc.).

Thus, it would be desirable to provide a method and system that overcomes the above-recited shortcoming in the conventional bonding methods.

### SUMMARY OF THE INVENTION

The present invention is directed to a method of bonding a bonding wire to a bonding pad of a bonding location (e.g., including a semiconductor device such as a die, a chip, a substrate, etc.) using a wire bonder and the wire bonder used therein. According to one exemplary embodiment, the method includes forming a bonding ball at an end of the bonding wire, pre-deforming at least a portion of the bonding ball, and bonding the pre-deformed ball to the bonding pad.

According to another exemplary embodiment of the present invention, a method of bonding a bonding wire to a bonding surface includes forming a bonding ball at an end of the bonding wire, pressing the bonding ball to a deforming surface to produce a deformed bonding ball having a deformed portion substantially matching a profile of at least a portion of the deforming surface, removing the deformed bonding ball from the deforming surface, and bonding the deformed portion of bonding ball to the bonding surface.

According to yet another exemplary embodiment of the present invention, a wire bonder for bonding a bonding wire to a bonding pad of a bonding location using a bonding tool is provided. The wire bonder includes a source of heat disposed adjacent the bonding tool to melt a portion of the bonding wire to produce a bonding ball at an end thereof, and a pre-deforming unit including a deforming surface to pre-deform at least a portion of the bonding ball.

These and other aspects will become apparent in view of the following.

### BRIEF DESCRIPTION OF THE DRAWINGS

Although the invention is illustrated and described herein with reference to specific embodiments, the invention is not intended to be limited to the details shown. Rather, various modifications may be made in the details within the scope and range of equivalents of the claims and without departing from the invention.

It is emphasized that, according to common practice, the various features of the drawings are not to scale. On the contrary, the dimensions of the various features are arbitrarily expanded or reduced for clarity. Included in the drawing are the following figures:

FIGS. 1A-1C are schematic views of portions of a wire bonder for illustrating a pre-deformed ball bonding method according to an exemplary embodiment of the present invention;

FIG. 2 is a flow diagram illustrating a pre-deformed ball bonding method according to an exemplary embodiment of the present invention; and FIG. 3 is a flow diagram illustrating a pre-deformed ball bonding method according to another exemplary embodiment of the present invention.

### DETAILED DESCRIPTION OF THE INVENTION

In the figures like numerals represent like features.

U.S. Pat. Nos. 5,176,311, 5,205,463, 5,884,834, 6,062,462, and 6,156,990, as well as United States Patent Publication No. 2004/0152292, relate to wire bonding technology, and are herein incorporated by reference in their entirety.

As used herein, the term “pre-deformed” refers to the deformation or partial deformation of a bonding ball before (in a stage prior to) the bonding ball is bonded to a desired location (e.g., including a bonding pad on a substrate, a bonding site on a die/chip, etc.).

The term “bonding ball” or “ball” is intended to refer to an end portion of a wire that is configured to be wirebonded to a desired location, and is not limited to ball shaped portions. As such, the shape of the bonding ball prior to deformation according to the present invention is not limited.

As used herein, the term semiconductor device refers to any of a number of devices including semiconductor dies, semiconductor chips, VLSI devices, integrated circuits, interconnect devices, substrates for mounting semiconductor chips/dies, etc., and any other device intended to be wire bonded to a substrate.

As used herein, the term substrate refers to any structure to which a semiconductor device is wire bonded, including but not limited to leadframes, printed circuit boards, cards, etc.

As used herein, the terms bonding surface and bonding pad refers to any contact on (which includes contacts integrated as part of) a semiconductor device (including a substrate) to which a wire is bonded.

The systems and techniques disclosed herein are applicable to various wire bonding operations (e.g., forward bonding operations, reverse bonding operations).

In various exemplary embodiments of the present invention, a bonding ball is pre-deformed before bonding to a bonding surface (e.g., a bonding pad) of a semiconductor device to reduce localized strain at or adjacent to an initial contact area. The localized strain is reduced because the initial contact area between the deformed ball and the bonding surface is increased. That is, the initial contact area is larger leading to a more uniform mating interface between the bonding ball and the bonding surface. Without such an initial contact area, localized strain hardening may lead to higher local bonding energy (e.g., shear strain) needed during a later bonding stage which, in turn, may lead to bonding surface fracture or cratering. By improving the mating interface between the bonding ball and the bonding surface, a more uniform bonding energy throughout the area of contact may be maintained and, for example, cratering and/or cracking of the bonding location may be reduced or substantially eliminated. Cratering may be reduced or substantially eliminated, for example, for ball bonding using relatively hard balls in comparison to the bonding location. Moreover, cracking may be reduced or substantially eliminated, for example, for ball bonding using a relatively fragile bonding location, such as those with low dielectric constant layers.

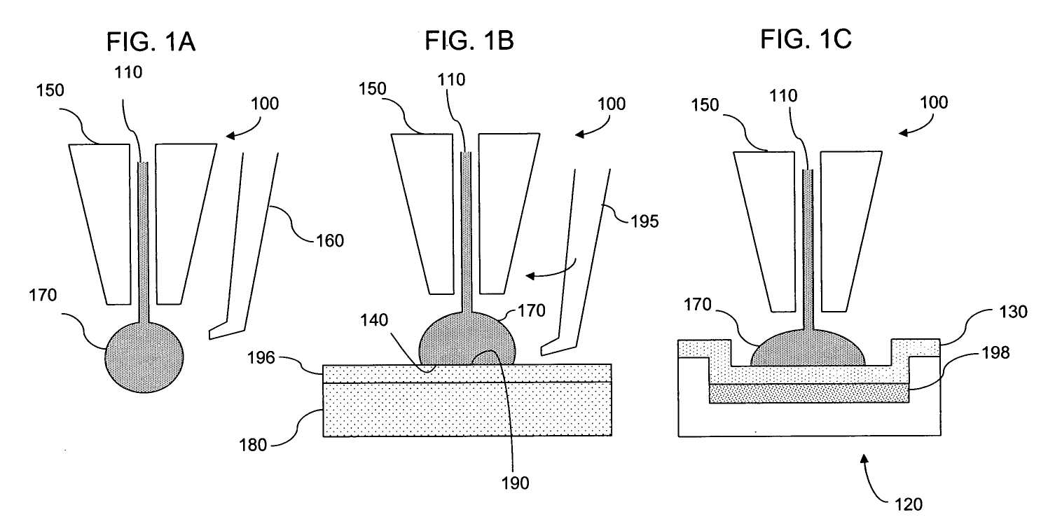

FIGS. 1A-1C are schematic views of portions of a wire bonder for illustrating a pre-deformed ball bonding method according to an exemplary embodiment of the present invention.

Referring now to FIGS. 1A-1C, a sequence of steps is shown using a wire bonder 100 to produce a wire bond according to an exemplary pre-deformed ball bonding method. While only a portion of a wire bonder is illustrated in FIG. 1., reference numeral 100 is intended to refer to the entire wire bonder (i.e., a wire bonding machine). Wire bonder 100 is configured to be used with bonding wire 110 and a bonding location 120 (e.g., including a semiconductor device such as a die, chip, interconnect device, substrate, etc.) having a bonding pad 130. Wire bonder 100 enables bonding of bonding wire 110 to bonding pad 130, and includes a wire bonding tool 150, for example, a capillary through which bonding wire 110 may be fed, a ball forming unit 160, for example, an electric flame off (EFO) unit to heat the end of bonding wire 110 to produce a bonding ball 170, a deforming unit 180, for example, a deforming surface, to pre-deform bonding ball 170 prior to bonding to bonding pad 130 of bonding location 120, and a controller (not shown) to control movement of wire bonding tool 150 to produce pre-deformed bonding ball 170 (as shown in FIG. 1B) and to bond pre-deformed bonding ball 170 to bonding pad 130.

As shown in FIG. 1A, bonding wire 110 may be fed, for example, through wire bonding tool 150 and bonding ball 170 having a substantially spherical shape may be formed at an end of bonding wire 110 by melting the end of bonding wire 110 using ball forming unit 160. As shown in FIG. 1B, after bonding ball 170 is formed, bonding ball 170 may be moved with wire bonding tool 150 to deforming unit 180 to pre-deform bonding ball 170 prior to bonding to bonding pad 130 of bonding location 120 (e.g., bonding location 120 is a semiconductor die and includes a bonding pad 130). That is, for example, bonding ball 170 may be pressed to produce a deformed bonding ball 170 having a deformed portion 140 matching a profile of at least a portion of a surface of deforming unit 180. Deformed bonding ball 170 may then be removed (separated) from deforming unit 180. As shown in FIG. 1C, deformed bonding ball 170 then may be bonded (e.g., ultrasonically bonded) to bonding pad 130 of bonding location 120 at deformed portion 140 of deformed bonding ball 170.

Deforming unit 180 may include a deforming surface and a heating unit 195 to anneal deformed bonding ball 170 contacting deforming surface 190. For example, deforming unit 180 may be incorporated into a supporting substrate by which semiconductor devices to be wirebonded are supported. Heating unit 195 may rotate around deformed bonding ball 170, as shown by the arrow in FIG. 1B to provide a more uniform heating of bonding ball 170. Heating unit 195 may be a moving EFO device which is formed from a noble rare earth metal, such as platinum, iridium, and palladium, among others.

Although it is shown that the heating unit 195 may be separate from that of the ball forming unit 160, it is possible that one device may provide both functions and if so the one device may travel with the bonding ball 170 to the deforming unit 180. Further still, certain exemplary embodiments of the present invention relate to deforming units (e.g., deforming surface on a substrate) which do not utilize a heating unit at all.

Ball deformation may lead to up to a 30% increase in deformed bonding ball hardness due to strain hardening, which may be compensated for by annealing using heating unit 195.

Although heating unit 195 is shown as moving around deformed ball 170, it is contemplated that deforming surface 190 may include a heat source (e.g., a hot plate). Further, other heating means may be employed adjacent to or surrounding deformed bonding ball 170, for example, an electric heating coil (not shown) to anneal at least a portion of deformed bonding ball 170. If deforming surface 190 is heated to produce annealing of deformed ball 170, at least a portion of deforming surface 190 contacting deformed bonding ball 170 may be formed from a noble rare earth metal, such as platinum, iridium, and palladium, among others. Otherwise, deforming surface 190 may include a surface coating 196 disposed on at least a portion of deforming surface 190 to prevent deformed bonding ball 170 from adhering to deforming surface 190. For example, surface coating 196 may be a layer comprising silicon nitride (SiN) or silicon dioxide (SiO₂), among others.

At least a portion of deforming surface 190 used to deform the bonding ball 170 may be shaped either substantially flat or, otherwise, substantially concave to produce either a substantially flat portion or substantially convex portion of bonding ball 170. The substantially concave surface of deforming surface 190 may have a curvature defined by an arcuate portion thereof having a diameter in the range of between 3 to 5 times the diameter of original bonding ball 170.

Bonding ball 170 may be pre-deformed to reduce localized strain at or adjacent to an initial contact area by enlarging the initial contact area (i.e., producing a more uniform mating interface) between deformed bonding ball 170 and bonding pad 130 to prevent cratering and/or cracking of bonding location 120. In particular, for pre-deformed bonding ball 170 being formed from a material that is harder than gold (e.g., copper, palladium or platinum, among others) and/or relatively harder than bonding location 120, cracking/cratering of bonding location 120 may be reduced or substantially eliminated.

When bonding location 120 includes a fragile material, such as a low dielectric constant material (e.g., having a dielectric constant of less than 3.0) [SiOC (i.e., Applied's “Black Diamond”), MSQ (i.e., methylsilsesquioxane), and/or HSQ (i.e., hydrogen silsesquioxane), among others] cracking of bonding location 120 may be reduced or substantially eliminated. In a bonding location that includes a fragile material, occurrence of cracking of bonding location 120 may increase due to the higher bonding energy needed for relatively harder bonding wire 110, which may damage the dielectric or other materials disposed underneath bonding pad 130. For example, a copper bonding wire with a Vicker hardness (Hv) of 50 may need 40% more energy for bonding than gold bonding wire with a Hv of 40. The higher the bonding energy (or the higher the bonding energy density), the larger the risk of fracture (cracking) of bonding location 120.

That is, when a gold bonding wire is used on a fracture-sensitive, lower modulus dielectric constructed bonding location (e.g., including a low-dielectric constant dielectric material), the bonding energy may cause a fracture of the dielectric structures causing device failure.

Bonding location 120 may include a semiconductor device (e.g., a die, a chip, etc.) having: (1) one or more layers 198, for example, silicon dioxide layers and/or fluorinated silicon glass (FSG) with via layer comprising via layers interposed between a plurality of metallization layers, such as aluminum layers, or (2) one or more layers 198 may include (e.g., for a copper interconnect bonding structure) silicon dioxide with via layers, FSG with via layers, silicon nitride with via layers or FSG with copper via layers interposed between the plurality of metallization layers, such as aluminum or copper layers, or (3) one or more layers 198 may include (e.g., for a copper interconnect having a low dielectric constant bonding structure), a silicon dioxide with via layers, FSG with via layers, silicon nitride with via layers or low dielectric constant dielectric layers, such as SiOC, MSQ, HSQ, among others, over copper via layers interposed between a plurality of metallization layers, such as aluminum or copper layers.

Although in the exemplary embodiment of the present invention illustrated in FIG. 1B, deforming unit 180 is shown including deforming surface 190, it is contemplated that other types of deforming units are possible, so long as a sufficient force is applied to a ball to produce deformation. For example, the deforming unit may be a pressured gas unit directed towards the ball or other force applying means.

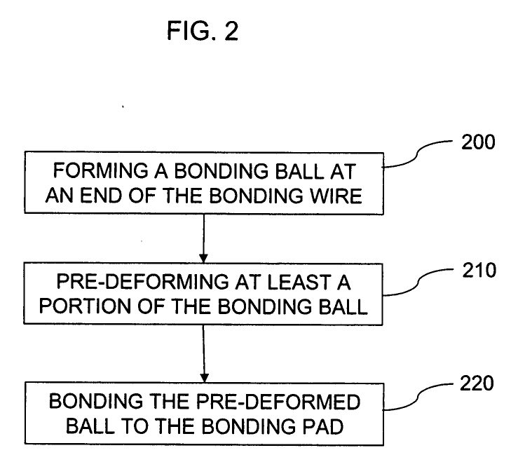

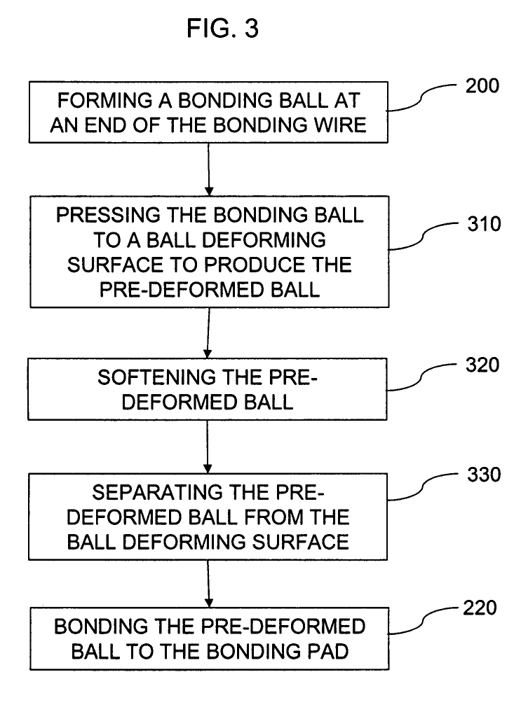

FIG. 2 is a flow diagram illustrating a pre-deformed ball bonding method according to an exemplary embodiment of the present invention.

Referring now to FIG. 2, at step 200, bonding ball 170 may be formed at the end of bonding wire 110 by ball forming unit 160. At step 210, bonding ball 170 may then be moved with wire bonding tool 150 to deforming unit 180 to pre-deform bonding ball 170 prior to bonding to bonding pad 130 of bonding location 120. At step 220, deformed bonding ball 170 may be moved to bonding pad 130 of bonding location 120 and bonded (e.g., ultrasonically bonded) to bonding pad 130 at deformed portion 140 of deformed bonding ball 170.

FIG. 3 is a flow diagram illustrating a pre-deformed ball bonding method according to another exemplary embodiment of the present invention.

Referring now to FIG. 3, at step 200, bonding ball 170 may be formed at the end of bonding wire 110 by ball forming unit 160. At step 310, bonding ball 170 may then be moved with wire bonding tool 150 to deforming unit 180 to press bonding ball 170 to ball deforming surface 190. Thus, pre-deformed bonding ball 170 having a deformed portion 140 substantially matching a profile of at least a portion of deforming surface 190 is produced.

Pressing step 310 may include the step of pressing bonding ball 170 to ball deforming surface 190 until a measured quantity reaches a predetermined value. The measured quantity may include, for example, a predetermined time after bonding ball 170 contacts deforming surface 190, a predetermined temperature of bonding ball 170 during deformation, a predetermined distance traveled by wire bonding tool 150 after bonding ball 170 contacts deforming surface 190 of deforming unit 180, or a predetermined capacitance between bonding ball 170 and an electrode (not shown) buried in deforming unit 180. For example, the predetermined quantity may be established so that the localized strain (with or without softening the bonding ball 170 at step 320) in or adjacent to the area of contact, defined by contacting portions of surfaces of pre-deformed bonding ball 170 and bonding pad 130, during bonding is less than a predetermined strain value and is sufficient to prevent both crating and/or cracking of bonding location 120.

At step 320, pre-deformed bonding ball 170 may be softened. Softening step 320 may reduce the hardness of pre-deformed bonding ball 170 by heating (e.g., annealing) pre-deformed bonding ball 170 using a hot stage, an electric flame off device or heating means for heating pre-deformed bonding ball 170. Deforming surface 190 may be employed as the hot stage. Moreover, the step of annealing pre-deformed bonding ball 170 may at least compensate for strain hardening caused by pressing step 310.

At step 330, pre-deformed bonding ball 170 may be separated from deforming surface 190. At step 220, pre-deformed bonding ball 170 may be moved to bonding pad 130 of bonding location 120 and may be bonded (e.g., ultrasonically) to bonding pad 130. That is, pre-deformed bonding ball 170 may be ultrasonically bonded to bonding pad 130 of bonding location 120 at deformed portion 140 of pre-deformed bonding ball 170.

According to certain exemplary embodiments of the present invention, the bonding location (e.g., including a semiconductor device such as a die, chip, interconnect structure, substrate, etc.) may comprise a number of different materials. For example, the bonding location may be a layered structure, including a contact pad disposed thereon (See FIG. 1C and related description above). In such embodiments, if the pre-deformed bonding ball (where the hardness of the pre-deformed bonded ball has increased through the deformation) is more resistant to plastic deformation than a material included in the bonding location (e.g., including the bonding pad material, the material included in one of the layers of a multi-layered structure, etc.), cratering and/or cracking of a portion of the bonding location may undesirably result during the bonding process. To prevent (or substantially limit the potential for) such cratering and/or cracking, the pre-deformed bonding ball may be annealed such that the resistance to plastic deformation (related to hardness, ductility, etc.) of the pre-deformed bonding ball is decreased. Further, in certain embodiments of the present invention, the resistance to plastic deformation of the pre-deformed bonding ball is close to (e.g., substantially the same as) the resistance to plastic deformation of the portion of the bonding location adjacent the pre-deformed bonding ball (e.g., the bonding pad of the bonding location).

While preferred embodiments of the invention are illustrated and described herein, it should be understood that such embodiments are provided by way of example only. Numerous variations, changes and substitutions can occur without departing from the scope and spirit of the invention.

What is claimed:

1. A method of bonding a bonding wire to a bonding pad of a bonding location for use with a wire bonder, the method comprising the steps of:
forming a bonding ball at an end of the bonding wire;
pre-deforming at least a portion of the bonding ball; and
bonding the pre-deformed ball to the bonding pad.

2. The method according to claim 1, wherein the pre-deforming step further comprises the steps of:
pressing the bonding ball to a ball deforming surface to produce the pre-deformed ball; and
separating the pre-deformed ball from the ball deforming surface.

3. The method according to claim 1, wherein the step of bonding the pre-deformed ball comprises ultrasonically bonding the pre-deformed ball to the bonding pad.

4. The method according to claim 2, wherein the step of pressing the bonding ball to the ball deforming surface comprises the step of pressing the pre-deformed ball to the ball deforming surface until a measured quantity reaches a predetermined value.

5. The method according to claim 4, wherein the measured quantity is one of:
a predetermined time after the bonding ball contacts the ball deforming surface as a result of the pressing step;
a predetermined temperature of the bonding ball during deformation;
a predetermined distance traveled by a wire bonding tool after the bonding ball contacts the ball deforming surface as a result of the pressing step; or
a predetermined capacitance between the pre-deformed ball and an electrode buried in the ball deforming surface such that localized strain in or adjacent to an area of contact between the pre-deformed ball and the bonding pad, during bonding, is less than a predetermined strain value.

6. The method according to claim 1, further comprising a step of annealing the pre-deformed bonding ball to reduce a resistance to plastic deformation of the pre-deformed bonding ball.

7. The method according to claim 1, wherein the bonding ball comprises copper, palladium, platinum, gold, or aluminum.

8. The method according to claim 1, wherein the pre-deformed bonding ball comprises a surface having a shape that is either substantially flat or substantially convex.

9. The method according to claim 8, wherein a shape of at least a portion the pre-deformed bonding ball substantially matches a profile of at least a portion of a ball deforming surface.

10. The method according to claim 1, further comprising the step of softening the pre-deformed bonding ball prior to the bonding step to reduce a hardness of the pre-deformed bonding ball.

11. The method according to claim 10, wherein the step of softening the pre-deformed ball comprises the step of annealing the pre-deformed bonding ball using a hot stage, an electric flame off device or heating means for heating the pre-deformed bonding ball.

12. The method according to claim 11, wherein the step of annealing the pre-deformed ball using the hot stage includes using a ball deforming surface as the hot stage, the ball deforming surface being contacted by the bonding ball during the step of pre-deforming.

13. The method according to claim 11, wherein the step of annealing the pre-deformed ball using the electric flame off device comprises moving the electric flame off device around the pre-deformed bonding ball to heat a surface of the pre-deformed bonding ball.

14. The method according to claim 11, wherein the step of annealing the pre-deformed bonding ball at least compensates for strain-hardening caused by the pre-deforming step.

15. A method of wire bonding a bonding wire to a wire bonding surface, comprising the steps of:
forming a bonding ball at an end of the bonding wire;
pressing the bonding ball to a deforming surface to produce a deformed bonding ball having a deformed portion substantially matching a profile of at least a portion of the deforming surface;
removing the deformed bonding ball from the deforming surface; and
bonding the deformed portion of the deformed bonding ball to the wire bonding surface.

16. A wire bonder for bonding a bonding wire to a bonding pad of a bonding location using a wire bonding tool, the wire bonder comprising:
a source of heat disposed adjacent the wire bonding tool to melt a portion of the bonding wire to produce a bonding ball at an end thereof; and
a pre-deforming unit comprising a deforming surface to pre-deform at least a portion of the bonding ball.

17. The wire bonder of claim 16, further comprising a controller to control the wire bonding tool to bond the pre-deformed bonding ball to the bonding pad.

18. The wire bonder according to claim 16, wherein the deforming surface comprises:
a heating unit to anneal the pre-deformed bonding ball contacting the deforming surface; and
a coating disposed on at least a portion of the deforming surface to prevent the pre-deformed bonding ball from adhering to the deforming surface.
